(19) United States
(12) Patent Application Publication
(10) Pub. No.: US 2026/0229943 A1
(43) Pub. Date: Aug. 6, 2026

(54) BUSBAR FOR HEAVY DUTY APPLICATION WITH INTEGRATED ENCAPSULATION WALL

(71) Applicant: Schaeffler Technologies AG & Co. KG, Herzogenaurach (DE)

(72) Inventors: Brian Foust, Lakewood, OH (US); Maximilian Podschwadt, Saline, MI (US)

(21) Appl. No.: 19/047,343

(22) Filed: Feb. 6, 2025

(51) Int. Cl. H02K 3/28; H02K 5/22; H02K 11/25

(52) U.S. Cl. CPC H02K 3/28; H02K 5/225; H02K 11/25; H02K 2203/09

(57) ABSTRACT

A busbar may include bars, bus pins connected to the bars, connection wires, and an overmold. The overmold may support the bars, the bus pins, connection wires. The connection wires may be configured to connect the bus pins and the bars. The overmold may configured to at least partially encapsulate each of the bars, the bus pins, and the connection wires. The overmold may define holes and a pass through. A stator may include the busbar, a stator core, windings, and a stator carrier. The winding may be connected to the bus pins. An electric motor may include the stator and a rotor.

### TECHNICAL FIELD

The present disclosure generally relates to electrical motors, and, more particularly, to busbars designed for demanding conditions.

### BACKGROUND

Electric motors may be used in environments that have demanding conditions, such as high temperatures, sediment, or being exposed to liquids. Without proper protection, these conditions may significantly shorten the lives of motors or cause immediate failure of the motors. Many methods for protecting electric motors from such conditions may be difficult to integrate into existing designs for electric motors. Therefore, it would be advantageous to provide a device, system, and method that cures the shortcomings described above.

### SUMMARY

A busbar is described, in accordance with one or more embodiments of the present disclosure. The busbar may include: a plurality of bars; a plurality of bus pins; a plurality of connection wires, wherein the plurality of connection wires are configured to connect each bus pin of the plurality of bus pins to at least one bar of the plurality of bars; and an overmold, wherein the overmold is configured to support the plurality of bars, the plurality of bus pins, and the plurality of connection wires, wherein the overmold is configured to at least partially encapsulate each of the plurality of bars, the plurality of bus pins, and the plurality of connection wires, wherein the overmold defines: a plurality of holes spaced about the overmold; and a pass through.

In some aspects, the busbar is configured as a delta busbar.

In some aspects, the pass through is located adjacent to the plurality of bars.

In some aspects, the overmold is configured to have a selected ingress protection (IP) rating.

In some aspects, the busbar is a three-phase busbar, wherein the plurality of bars comprise a first-phase bar, a second-phase bar, and a third-phase bar, wherein the plurality of bus pins comprise a plurality of first-phase bus pins, a plurality of second-phase bus pins, and a plurality of third-phase bus pins, wherein the plurality of first-phase bus pins are connected to the first-phase bar by a first phase connection wire, wherein the plurality of second-phase bus pins are connected to the second-phase bar by a second phase connection wire, wherein the plurality of third-phase bus pins are connected to the third-phase bar by a third phase connection wire.

In some aspects, the plurality of bus pins includes a plurality of bus pin sets.

In some aspects, each bus pin set of the plurality of bus pin sets includes a first-phase bus pin, a second-phase bus pin, and a third phase bus pin.

In some aspects, the pass through prevents the plurality of connection wires from forming a closed loop.

A stator is described, in accordance with one or more embodiments of the present disclosure. The stator may include a busbar. The busbar may include a plurality of bars; a plurality of bus pins; a plurality of connection wires, wherein the plurality of connection wires are configured to connect each bus pin of the plurality of bus pins to at least one bar of the plurality of bars; and an overmold, wherein the overmold is configured to support the plurality of bars, the plurality of bus pins, and the plurality of connection wires, wherein the overmold is configured to at least partially encapsulate each of the plurality of bars, the plurality of bus pins, and the plurality of connection wires. The overmold may define a plurality of holes spaced about the overmold; and a pass through; a stator core; a plurality of windings, wherein each winding of the plurality of windings is electrically connected to the two of bus pins of the plurality of bus pins; and a stator carrier.

In some aspects, the busbar is located radially outwards of the stator carrier.

In some aspects, the busbar further includes: a plurality of supports, wherein the plurality of supports are configured to support the busbar against the stator carrier.

In some aspects, the stator further includes a temperature sensor.

In some aspects, the temperature sensor is located between two windings of the plurality of windings.

In some aspects, the temperature sensor exits the stator by a channel in the overmold.

In some aspects, the overmold further defines: a plurality of alignment holes, wherein the plurality of alignment holes are configured to align the stator with the busbar.

In some aspects, the overmold is configured to have a geometry to support the laser welding of each winding of the plurality of windings to the two of bus pins of the plurality of bus pins.

In some aspects, the plurality of holes spaced about the overmold are configured such that the need for tooling in potting of the stator is eliminated.

In some aspects, the entire stator is encapsulated by the potting.

In some aspects, one winding of the plurality of windings traverses a gap caused by the pass through.

A motor is described, in accordance with one or more embodiments of the present disclosure. The motor may include a rotor; and a stator including a busbar. The busbar may include a plurality of bars; a plurality of bus pins; a plurality of connection wires, wherein the plurality of connection wires are configured to connect each bus pin of the plurality of bus pins to at least one bar of the plurality of bars; and an overmold, wherein the overmold is configured to support the plurality of bars, the plurality of bus pins, and the plurality of connection wires, wherein the overmold is configured to at least partially encapsulate each of the plurality of bars, the plurality of bus pins, and the plurality of connection wires. The overmold may define a plurality of holes spaced about the overmold; and a pass through; a stator core; a plurality of windings, wherein each winding of the plurality of windings is electrically connected to the two of bus pins of the plurality of bus pins; and a stator carrier.

### BRIEF DESCRIPTION OF THE DRAWINGS

The numerous advantages of the disclosure may be better understood by those skilled in the art by reference to the accompanying figures in which:

FIG. 1A depicts a top-front perspective view of a busbar, in accordance with one or more embodiments of the present disclosure.

FIG. 1B depicts a bottom-front perspective view of the busbar, in accordance with one or more embodiments of the present disclosure.

FIG. 1C depicts a top view of the busbar, in accordance with one or more embodiments of the present disclosure.

FIG. 1D depicts a bottom view of the busbar, in accordance with one or more embodiments of the present disclosure.

FIG. 1E depicts a side cross sectional view of the busbar, in accordance with one or more embodiments of the present disclosure.

FIG. 1F depicts a partial side cross sectional of the busbar, in accordance with one or more embodiments of the present disclosure.

FIG. 1G depicts a partial bottom perspective view of the busbar, in accordance with one or more embodiments of the present disclosure.

FIG. 2A depicts a top-front perspective view of an encapsulated stator with the busbar, in accordance with one or more embodiments of the present disclosure.

FIG. 2B depicts a partial perspective view of the stator with the busbar, in accordance with one or more embodiments of the present disclosure.

FIG. 2C depicts a top view of the stator with the busbar, in accordance with one or more embodiments of the present disclosure.

FIG. 2D depicts a bottom view of the stator with the busbar, in accordance with one or more embodiments of the present disclosure.

FIG. 2E depicts a side cross sectional view of the stator with the busbar, in accordance with one or more embodiments of the present disclosure.

FIG. 2F depicts a side cross sectional view of the stator with the busbar, in accordance with one or more embodiments of the present disclosure.

FIG. 3 depicts an electric motor, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to busbar. The busbar may include bars, bus pins connected to the bars, a neutral bus, and an overmold. The overmold may support the bars, the bus pins, and the neutral bus. The overmold may also be configured to at least partially encapsulate each of the bars, bus pins, and connection wires. The overmold may also define holes spaced about the overmold and a pass through. A stator may include the busbar, a stator core, windings, and a stator carrier. The windings may each be electrically connected to two bus pins. An electric motor may include the stator and a rotor.

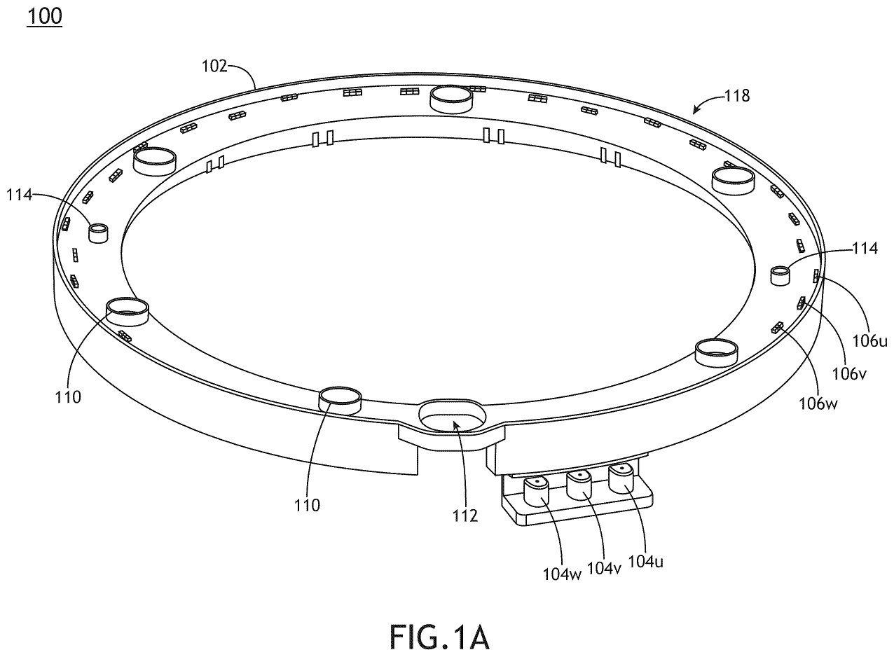

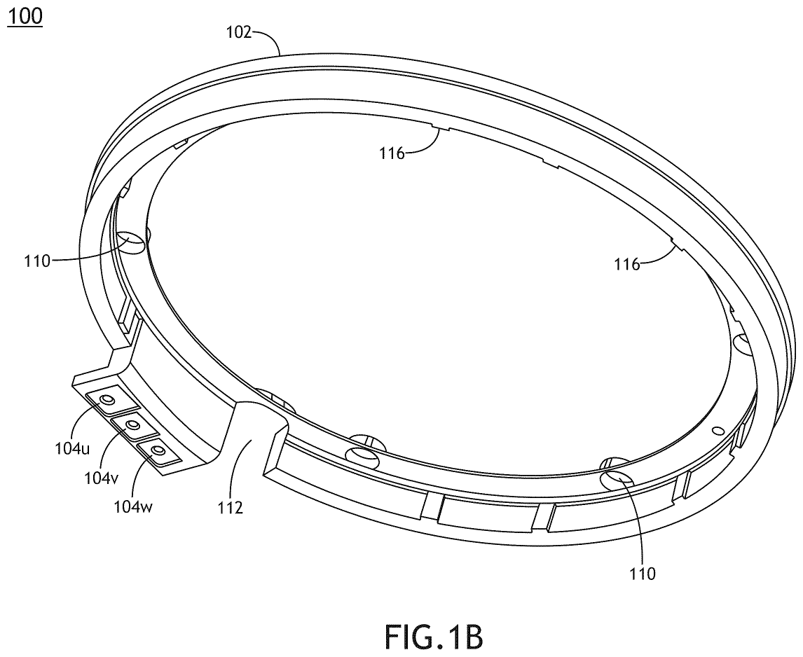

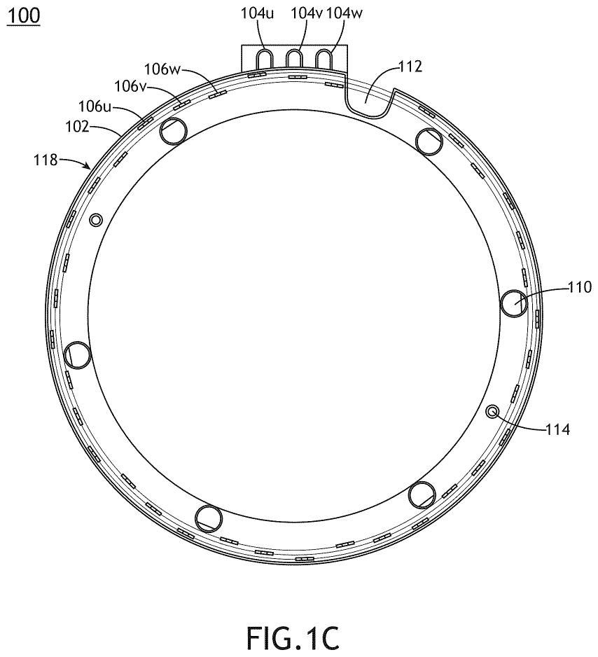

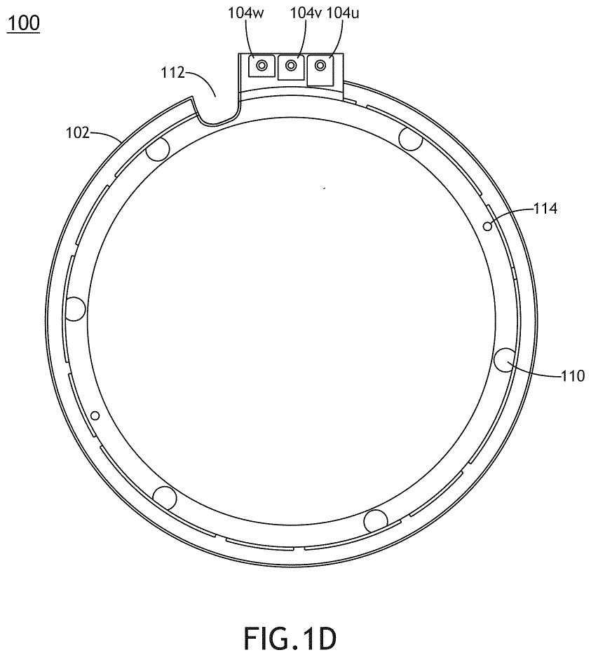

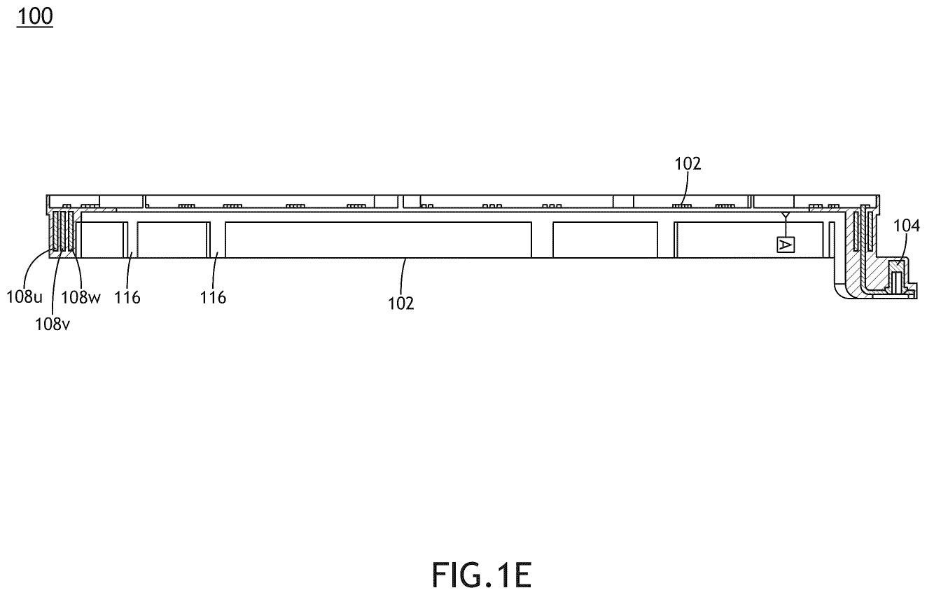

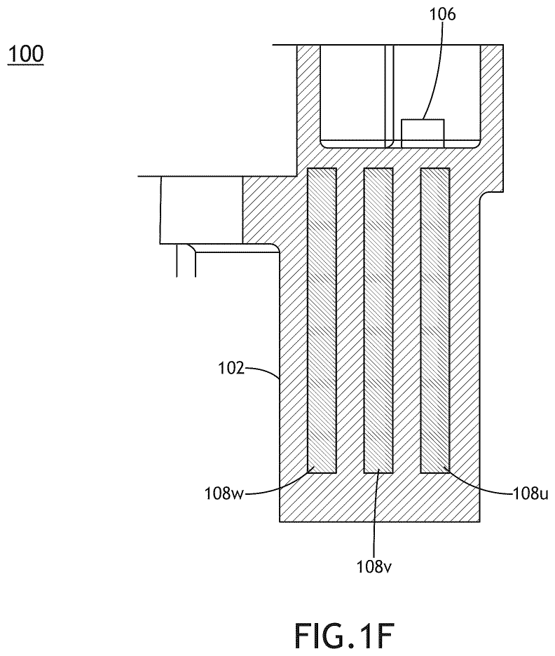

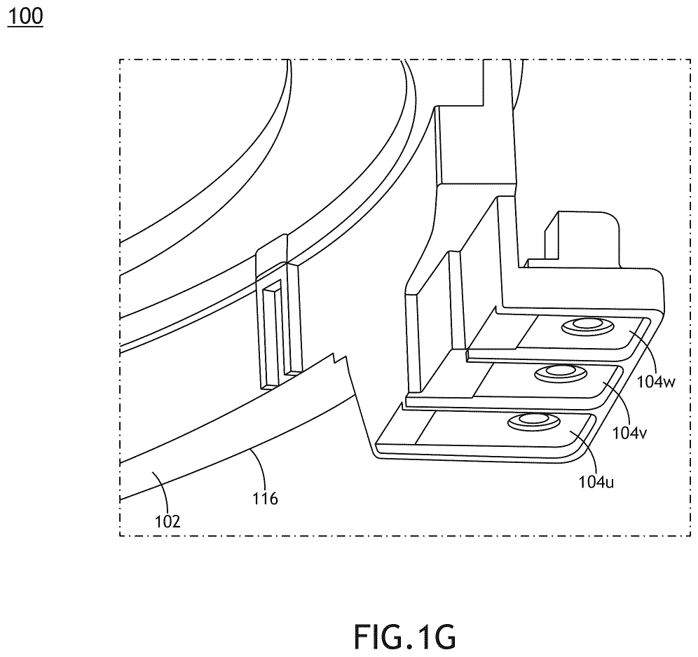

FIGS. 1A-1G depict a busbar 100, in accordance with one or more embodiments of the present disclosure. The busbar 100 may be a connection bar for a stator of an electric motor. The busbar 100 may include one or more components, such as, but not limited to, an overmold 102, bars 104, bus pins 106, and/or connection wires 108.

The busbar 100 may receive and distribute three currents. For example, the bus pins 106 may receive the current by the bars 104 and distribute the current from the bus pins 106. The bars 104, the bus pins 106, and/or the connection wires 108 may be made from any electrically conductive material. The electrically conductive material may be a rigid metallic element formed from metal. For example, the bars 104, the bus pins 106, and/or the connection wires 108 may be made from copper, a copper alloy, or the like.

The overmold 102 may support the bars 104, the bus pins 106, and the connection wires 108. For example, the bars 104, the bus pins 106, and connection wires 108 may be coupled to the overmold 102. The overmold 102 may bear the weight from the bars 104, the bus pins 106, and the connection wires 108.

The overmold 102 may be an electrical insulator. The overmold 102 may be any material which is an electrical insulator to insulate the bars 104, the bus pins 106, and the connection wires 108. The overmold 102 may be made of a plastic material or the like. The plastic material may include one or more material properties, such as, but not limited to, high electrical resistance, high rigidity, high shock resistance, high resilience, high resistance to thermal deformation, very high dimensional stability, good sliding properties, good fatigue resistance, easy to machine, and/or good resistance to chemicals such as organic solvents and fuels.

The plastic material may include, but is not limited to, polyamide (e.g., PA6, PA66), polyphthalamide (PPA), or the like. For example, the polyamide may be PA6, PA66, or the like. The plastic material may be a fiber-reinforced matrix which is impregnated with one or more fibers. The fibers may include glass, fiberglass, carbon fiber, aramid, carbon fibers, or the like. The fibers may include a load percentage. The load percentage of the fibers may be between 30% and 40%. For example, the plastic material may be polyamide 66 with 30% glass fiber (i.e., PA66-GF30). By way of another example, the plastic material may be polyphthalamide with 40% glass fiber (i.e., PPA-GF 40). However, it should be noted that any plastic material suitable for withstanding demanding conditions may be used to form the overmold 102.

The overmold 102 may be plastic injection molded. For example, the overmold 102 may be plastic injection molded over portions of the bars 104, the bus pins 106, and/or the connection wires 108.

The overmold 102 may be configured to have a largely circular profile. However, the overmold 102 need not be a circular shape and may be any shape that allows the overmold 102 to fit around a stator and/or work within an electric motor.

The overmold 102 may be configured such that the busbar 100, a stator, and/or a motor have a selected ingress protection (IP) rating. The busbar 100 may be dust tight. For example, the busbar 100 may be designed to have an ingress protection rating of 67. By way of another example, the busbar 100 may be designed to have an ingress protection rating of 6k9k. However, these ratings are intended to be illustrative rather than limiting.

The overmold 102 may define holes 110, a pass through 112, and/or alignment holes 114. The holes 110, the pass through 112, and/or the alignment holes 114 may axially extend through the overmold 102.

The holes 110 may be spaced about the overmold 102. The holes 110 may be evenly spaced around the overmold 102. However, this is not required and the holes 110 may be placed at any locations around the overmold 102. The holes 110 may be configured to allow bolts or other tooling required in conjunction with the stator and/or electric motor. The holes 110 may not prevent the connection wires 108 from forming a closed loop. For example, the holes 110 may be disposed radially inwards of the connection wires 108. For instance, the holes 110 may be defined by a flange of the overmold 102 which extends radially inwards from the portion of the overmold 102 defining the pass through 112 and housing the connection wires 108.

The pass through 112 may be any opening in the overmold 102 such that a tool may be used in conjunction with the busbar 100. The pass through 112 may be configured either as a hole though the overmold 102 and busbar 100 or as a notch out of the perimeter of the overmold 102 and busbar 100. For example, as shown in FIGS. 1A-1G, the pass through 112 is configured as a notch out of the perimeter of the overmold 102.

The pass through 112 may be radially and axially aligned with the connection wires 108. Additionally, the pass through 112 may interrupt the connection wires 108 such that the connection wires 108 do not form a closed loop (e.g., prevent a closed loop). Because the connection wires 108 may not form a close loop, a thicker material may be required to avoid unwanted temperatures from being reached during operation in the connection wires 108.

The connection wires 108 may correspond to the three phases of the bars 104 and the bus pins 106. In this way, the connection wires 108 may include one each of a first-phase connection wire 108u, a second-phase connection wire 108v, and a third-phase connection wire 108w. As such, the first-phase connection wire 108u may be configured to transfer a first-phase of electricity from the first-phase bar 104u to the first-phase bus pin 106u, the second-phase connection wire 108v may be configured to transfer a second-phase of electricity from the second-phase bar 104v to the second-phase bus pin 106v, and the third-phase connection wire 108w may be configured to transfer a third-phase of electricity from the third-phase bar 104w to the third-phase bus pin 106w.

The pass through 112 may also be located adjacent to the bars 104. However, the pass through 112 is not required to be located adjacent to the bars 104 and may be located at any point around the busbar 100. For example, the pass through 112 may be located opposite the bars 104. By way of another example, the pass through 112 may be located 90 degrees from the bars 104. However, these exemplary location of the pass through 112 are intended to be illustrative rather than limiting.

The alignment holes 114 may be smaller than the holes 110. For example, the alignment holes 114 may be configured so that dowels (e.g., rods) may be used when aligning components of an electric motor (e.g., a stator carrier).

The overmold 102 may further include supports 116. The supports 116 may be created in the process of forming the overmold 102. The supports 116 may be spaced about the overmold 102. For example, the supports 116 may be spaced evenly about the overmold 102. By way of another example, the supports 116 may be spaced unevenly about the overmold 102. It is contemplated that the location and size of the supports 116 may be dictated by design constraints, such as the size and shape of the stator carrier 202 and/or the busbar 100.

The bus pins 106 may be arranged into bus pin sets 118. For example, each bus pin set 118 may include three bus pins 106. The three bus pins 106 may be one each of a first-phase bus pin 106u, a second-phase bus pin 106v and a third-phase bus pin 106w. Therefore, each bus pin 106 in the bus pin set may correspond to one of the bars 104. The bus pins 106 in the bus pin sets 118 may be spaced circumferentially and radially (e.g., the bus pins 106 may be staggered). Additionally, the bus pins 106 in each bus pin set 118 may have the same order. For example, the outermost bus pin 106 of each bus pin set 118 may be a first-phase bus pin 106u, the middle bus pin 106 of each bus pin set 118 may be a second-phase bus pin 106v, and the innermost bus pin 106 of each bus pin set 118 may be a third-phase bus pin 106w. However, this ordering is intended to be exemplary rather than limiting, as the bus pin sets 118 may have any order. However, the connection wires 108 may dictate that all bus pin sets 118 include the same order of bus pins 106. The bus pin sets 118 may also be arranged in a polar array about a center axis of the busbar 100.

The busbar 100 may be a three-phase busbar. The busbar 100 may receive and distribute three phases of current. For example, the bus pins 106 may receive the three phases of current by the bars 104 and distribute the three phases of current from the bus pins 106. The three phases may include a first-phase (u), a second-phase (v), and a third-phase (w). The first-phase (u), the second-phase (v), and the third-phase (w) may be aligned 120-degrees out of phase.

The bars 104 may be rigid elements. Each of the bars 104 may be associated with a respective phase of electricity. The busbar 100 may include any number of the bars 104. The bars 104 may include a first-phase bar 104u, a second-phase bar 104v, and a third-phase bar 104w. The first-phase bar 104u may be associated a first-phase (u) of electricity, the second-phase bar 104v may be associated with a second-phase (v) of electricity, and the third-phase bar 104w may be associated with a third-phase (w) of electricity, respectively.

The busbar 100 may include the first-phase bar 104u, the second-phase bar 104v, and the third-phase bar 104w arranged in a sequence. For example, the second-phase bar 104v may be disposed between the first-phase bar 104u and the third-phase bar 104w.

The bus pins 106 may be rigid elements. The bus pins 106 may be connected to the bars 104. Each of the bus pins 106 may be associated with a respective phase of electricity. For example, the bus pins 106 may include first-phase bus pins 106u, second-phase bus pins 106v, and third-phase bus pins 106w. The first-phase bus pins 106u may be connected to the first-phase bar 104u, the second-phase bus pins 106v may be connected to the second-phase bar 104v, and the third-phase bus pins 106w may be connected to the third-phase bar 104w, respectively. The bus pins 106 may be connected to the bars 104 via the connection wires 108 within the overmold 102 of the busbar 100 for distributing current from the bars 104 to the bus pins 106.

The busbar 100 in the present disclosure may be configured as a delta busbar 100. As such, the busbar 100 may not include a neutral bus.

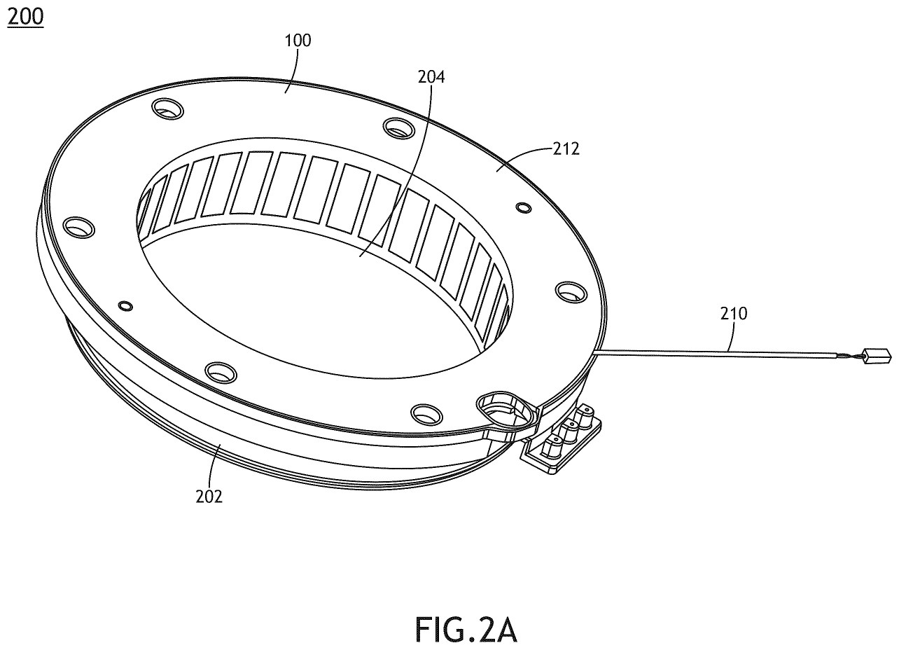

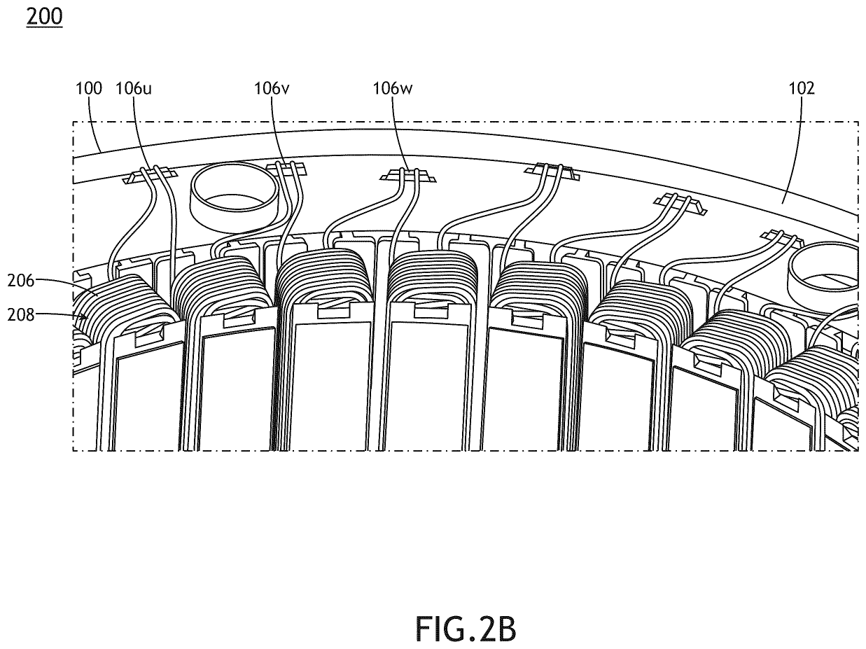

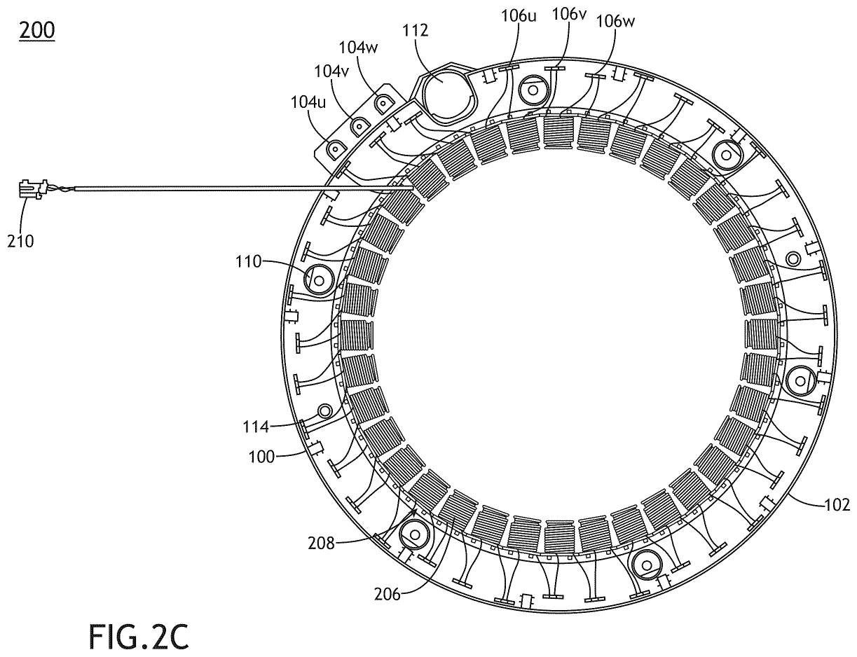

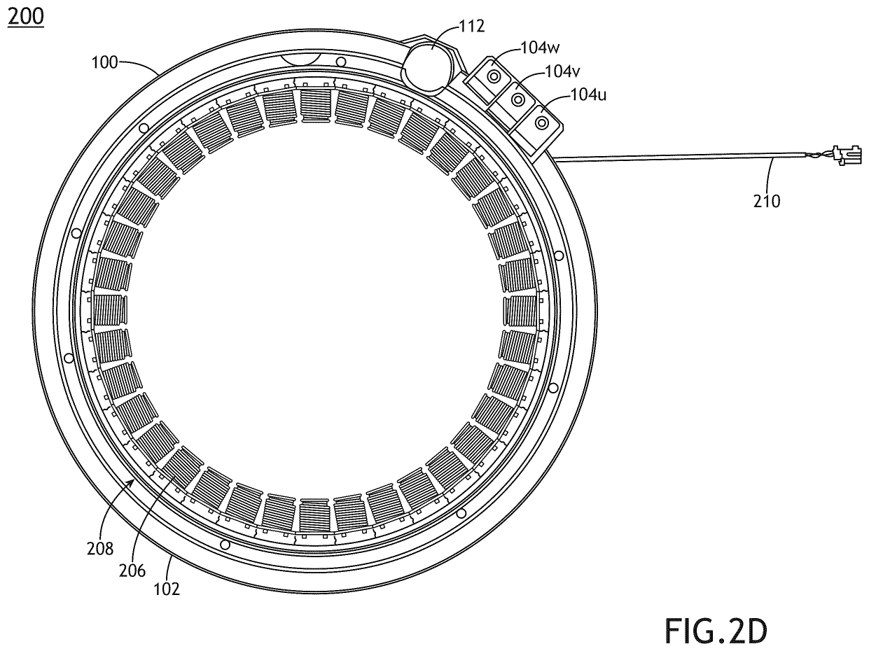

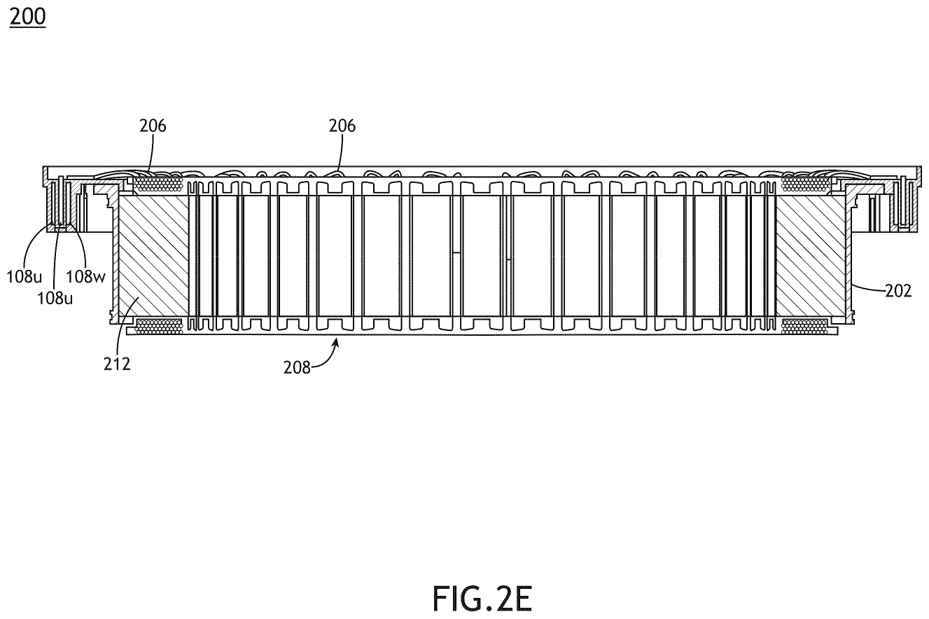

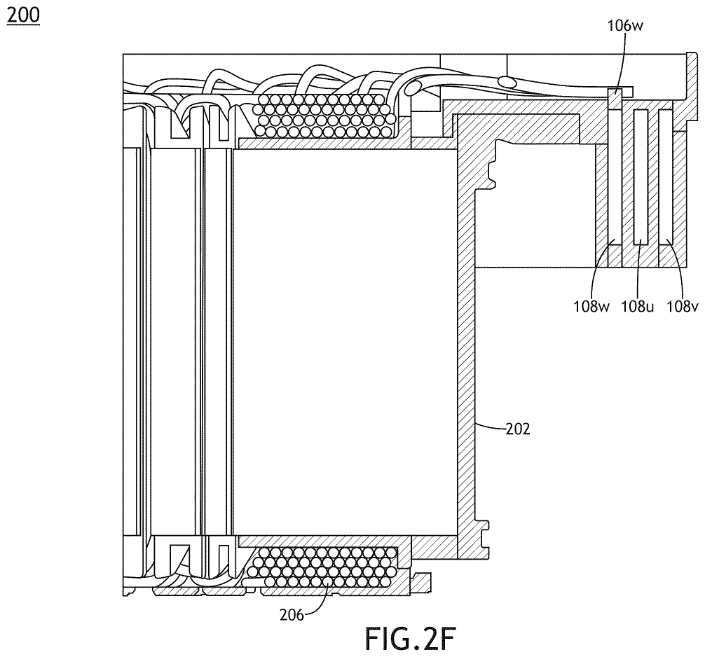

FIGS. 2A-2F depict a stator 200, in accordance with one or more embodiments of the present disclosure. The stator 200 may include the busbar 100, a stator carrier 202, a stator core 204, windings 206, stator teeth 208, and/or a temperature sensor 210. The busbar 100 may be located radially outward with respect to the stator carrier 202. In this way, the busbar 100 may not be placed above the stator 200 and/or the stator carrier 202.

The windings 206 may include any suitable type of winding, such as, but not limited to, a concentrated winding (e.g., wound over one of the stator teeth 208), distributed windings (e.g., wound over two or more stator teeth 208), or the like. As depicted, the windings 206 are concentrated windings, although this is not intended to be limiting. In this way, the stator 200 may include a plurality of windings 206. Each of the stator teeth 208 may include a winding 206.

The windings 206 may be electrically connected to the busbar 100. For example, each winding 206 may be electrically connected to two of the bus pins 106. For example, each winding 206 may be connected to the bus pins 106 at either end of the wire forming the winding 206. In this way, each winding 206 may be connected to two phases of current (e.g., the two phases associated with the two bus pins 106). For example, a winding 206 may be attached to a first-phase bus pin 106u and a second-phase bus pin 106v. By way of another example, a winding 206 may be attached to a second-phase bus pin 106v and a third-phase bus pin 106w. By way of another example, a winding may be attached to a first-phase bus pin 106u and a third-phase bus pin 106w. Additionally, each bus pin 106 may have at least two windings 206 connected to it.

It is contemplated that the busbar 100 may be configured such that one winding 206 may traverse a gap in the busbar 100 that is caused by the pass through 112. For example, the winding 206 may be coupled to the bus pins 106 on each circumferential side of the pass through 112, thereby traversing the gap. In this way, the windings 206 may cause the system to be connected, even when the connection wires 108 are not fully connected due to the pass through 112.

The windings 206 may be coupled to the bus pins 106 of the busbar 100 by laser welding. The busbar 100 may be configured to have a geometry to support the laser welding of the winding 206 to the bus pins 106. For example, the geometry of the busbar 100 configured to facilitate the laser welding of the winding 206 to the bus pins 106 may include grooves in the bus pins 106, where the grooves are configured to provide a profile similar to the wires of the winding 206. Therefore, the wires of the winding 206 may rest in the grooves during and after they are laser welded to the bus pins 106. In this way, the busbar 100 may facilitate improved capabilities for electrically coupling the busbar 100 to the stator 200.

In embodiments, the stator 200 may include a temperature sensor 210. The temperature sensor 210 may be located at any location within the stator 200. For example, the temperature sensor 210 may be positioned such that the temperature sensor 210 is located between two of the windings 206. Additionally, the temperature sensor 210 may exit the stator 200 by a channel in the overmold 102.

The stator carrier 202 may be a housing for the components of the stator 200. The stator carrier 202 may encapsulate the stator core 204, the winding 206, and the like. The stator core 204 and/or the windings 206 may be disposed within the stator carrier 202.

The stator carrier 202 may be attached to the various components of the stator 200 using any suitable process. For example, the stator carrier 202 may be attached by heating up the stator carrier 202 (e.g., to approximately 180 degrees centigrade) and then placing the stator carrier 202 around the other components. As the stator carrier 202 cools, it may shrink and become affixed to the other components. By way of another example, the stator carrier 202 may be staked (e.g., plastically deformed).

The stator core 204 may be made of stacks of one or more stacks of lamination. The stator core 204 may define one or more slots for the windings 206. The windings 206 of the stator 200 may disposed in the slots of the stator core 204. The busbar 100 may or may not be directly coupled to the stator carrier 202 and/or the stator core 204. For example, the busbar 100 may be epoxied to one or more components of the stator 200. By way of another example, the busbar 100 and/or components of the stator 200 may be designed such that the busbar 100 snaps into place on the stator 200.

It is contemplated that in order to maintain the ingress protection rating, the stator may include potting 212. The potting 212 may be filled into the stator 200 from the bottom up. Additionally, a lip may be included to ensure the potting 212 does not push the busbar 100 off the stator 200. The potting 212 may be distributed in the stator 200 by mass.

Potting 212 may generally be any material suitable for encapsulating the stator 200 and/or components of the stator. For example, the potting 212 may be a plastic.

The overmold 102 may be configured such the plurality of holes 110 spaced about the overmold 102 eliminate the need for tooling in potting 212 of the stator 200. In this way, the entire stator 200 may be encapsulated by the potting 212. This may be beneficial, as encapsulating the entire stator 200 with potting 212 may prevent unwanted material from contacting the stator 200 and result in the ability to have a high IP rating.

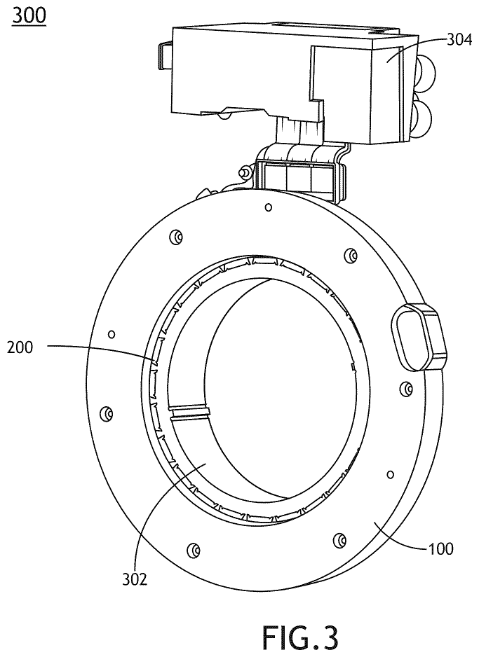

FIG. 3 depicts an electric motor 300, in accordance with one or more embodiments of the present disclosure. The electric motor 300 may be a three-phase electric motor. The electric motor 300 may include the stator 200, a rotor 302, and/or a junction box 304.

The junction box 304 may receive current from one or more external components. For example, the junction box 304 may receive current from an inverter, controller, or the like. The junction box 304 may receive one or more phases of current. The junction box 304 may receive the three phases of current, including the first-phase (u), the second-phase (v), and the third-phase (w).

The junction box 304 may be connected to the busbar 100. The busbar 100 may receive the current from the junction box 304. The bars 104 of the busbar 100 may couple to the junction box 304 for receiving the current. The bus pins 106 may connect to the windings 206. The busbar 100 may distribute the three phases of current to the windings 206. For example, the bus pins 106 may be connected to the windings 206 for distributing the three phases of current. The windings 206 may receive the current from the busbar 100. The windings 206 may induce a magnetic field in response to receiving the three phases of current from the busbar 100.

The rotor 302 may be disposed within the central axis of the stator 200. The rotor 302 may be supported by the stator 200 via one nor more bearings. The magnetic field induced by the windings 206 may cause the rotor 302 to rotate relative to the stator 200. The rotor 302 may perform work on one or more external components via the rotation of the rotor 302. Thus, the electric motor 300 may be a dynamo-electric machine which converts electrical energy to mechanical energy by electromagnetic means. In this way, causing the rotor 302 to help crank the engine.

It should be noted that the electric motor 300 may also be configured to convert mechanical energy to electrical energy (e.g., act as a generator).

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, the term “axial” and derivatives thereof, such as “axially,” shall be understood to refer to a direction along the axis. The term “coaxial” shall be understood to refer to a common axis. Further, the term “radial” and derivatives thereof, such as “radially,” shall be understood in relation to the axis. For example, “radially outward” refers to further away from the axis, while “radially inward” refers to nearer to the axis. The term “circumference” or derivatives thereof, such as “circumferentially”, may also be defined in reference to the center axis.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 busbar
102 overmold
104 bars
104u first-phase bar
104v second-phase bar
104w third-phase bar
106 bus pins
106u first-phase bus pins
106v second-phase bus pins
106w third-phase bus pins
108 connection wires
108u first-phase connection wire
108v second-phase connection wire
108w third-phase connection wire
110 holes
112 pass through
114 alignment holes
116 supports
118 bus pin sets
200 stator
202 stator carrier
204 stator core
206 windings
208 stator teeth
210 temperature sensor
212 potting
300 electric motor
302 rotor
304 junction box

What is claimed:

1. A busbar comprising:
a plurality of bars;
a plurality of bus pins;
a plurality of connection wires, wherein the plurality of connection wires are configured to connect each bus pin of the plurality of bus pins to at least one bar of the plurality of bars; and
an overmold, wherein the overmold is configured to support the plurality of bars, the plurality of bus pins, and the plurality of connection wires, wherein the overmold is configured to at least partially encapsulate each of the plurality of bars, the plurality of bus pins, and the plurality of connection wires, wherein the overmold defines:
a plurality of holes spaced about the overmold; and
a pass through.

2. The busbar of claim 1, wherein the busbar is configured as a delta busbar.

3. The busbar of claim 1, wherein the pass through is located adjacent to the plurality of bars.

4. The busbar of claim 1, wherein the overmold is configured to have a selected ingress protection (IP) rating.

5. The busbar of claim 1, wherein the busbar is a three-phase busbar, wherein the plurality of bars comprise a first-phase bar, a second-phase bar, and a third-phase bar, wherein the plurality of bus pins comprise a plurality of first-phase bus pins, a plurality of second-phase bus pins, and a plurality of third-phase bus pins, wherein the plurality of first-phase bus pins are connected to the first-phase bar by a first phase connection wire, wherein the plurality of second-phase bus pins are connected to the second-phase bar by a second phase connection wire, wherein the plurality of third-phase bus pins are connected to the third-phase bar by a third phase connection wire.

6. The busbar of claim 5, wherein the plurality of bus pins includes a plurality of bus pin sets.

7. The busbar of claim 6, wherein each bus pin set of the plurality of bus pin sets includes a first-phase bus pin, a second-phase bus pin, and a third phase bus pin.

8. The busbar of claim 1, wherein the pass through prevents the plurality of connection wires from forming a closed loop.

9. A stator comprising:
a busbar comprising:
a plurality of bars;
a plurality of bus pins;
a plurality of connection wires, wherein the plurality of connection wires are configured to connect each bus pin of the plurality of bus pins to at least one bar of the plurality of bars; and
an overmold, wherein the overmold is configured to support the plurality of bars, the plurality of bus pins, and the plurality of connection wires, wherein the overmold is configured to at least partially encapsulate each of the plurality of bars, the plurality of bus pins, and the plurality of connection wires, wherein the overmold defines:
a plurality of holes spaced about the overmold; and
a pass through;
a stator core;
a plurality of windings, wherein each winding of the plurality of windings is electrically connected to the two of bus pins of the plurality of bus pins; and
a stator carrier.

10. The stator of claim 9, wherein the busbar is located radially outwards of the stator carrier.

11. The stator of claim 9, wherein the busbar further comprises:
a plurality of supports, wherein the plurality of supports are configured to support the busbar against the stator carrier.

12. The stator of claim 9, further comprising a temperature sensor.

13. The stator of claim 12, wherein the temperature sensor is located between two windings of the plurality of windings.

14. The stator of claim 12, wherein the temperature sensor exits the stator by a channel in the overmold.

15. The stator of claim 9, wherein the overmold further defines:
a plurality of alignment holes, wherein the plurality of alignment holes are configured to align the stator with the busbar.

16. The stator of claim 9, wherein the overmold is configured to have a geometry to support laser welding of each winding of the plurality of windings to the two of bus pins of the plurality of bus pins.

17. The stator of claim 9, wherein the plurality of holes spaced about the overmold are configured such that a need for tooling in potting of the stator is eliminated.

18. The stator of claim 17, wherein the stator is entirely encapsulated by the potting.

19. The stator of claim 9, wherein one winding of the plurality of windings traverses a gap caused by the pass through.

20. A motor comprising:
a rotor; and
a stator comprising:
a busbar comprising:
a plurality of bars;
a plurality of bus pins;
a plurality of connection wires, wherein the plurality of connection wires are configured to connect each bus pin of the plurality of bus pins to at least one bar of the plurality of bars; and
an overmold, wherein the overmold is configured to support the plurality of bars, the plurality of bus pins, and the plurality of connection wires, wherein the overmold is configured to at least partially encapsulate each of the plurality of bars, the plurality of bus pins, and the plurality of connection wires, wherein the overmold defines:
a plurality of holes spaced about the overmold; and
a pass through;
a stator core;
a plurality of windings, wherein each winding of the plurality of windings is electrically connected to the two of bus pins of the plurality of bus pins; and
a stator carrier.
